(19) United States
(12) Patent Application Publication
(10) Pub. No.: US 2007/0239742 A1
(43) Pub. Date: Oct. 11, 2007

(54) DETERMINING DATA ELEMENTS IN HETEROGENEOUS SCHEMA DEFINITIONS FOR POSSIBLE MAPPING

(75) Inventors: Rakesh SAHA, Bangalore (IN); Aninda SENGUPTA, Bangalore (IN)

Correspondence Address: LAW FIRM OF NAREN THAPPETA, 158, PHASE ONE PALM MEADOWS, RAMAGUNDANAHALLI, AIRPORT WHITEFIELD ROAD, BANGALORE, 560043, IN

(73) Assignee: ORACLE INTERNATIONAL CORPORATION, Redwood Shores, CA (US)

(21) Appl. No.: 11/308,911

(22) Filed: May 25, 2006

(30) Foreign Application Priority Data
Apr. 6, 2006 (IN) 637/CHE/2006

(51) Int. Cl. G06F 7/00

(52) U.S. Cl. 707/101

(57) ABSTRACT

Determining data elements for possible mapping in heterogeneous schema definitions. According to one aspect of the present invention, a user indicates whether two non-leaf elements (in respective schemas) are structurally similar, and the probability of possible match of a first element (in a first schema) and a second element (in a second schema) as a synonym pair is computed to be more if the two elements are below the respective ones of the structurally similar nodes, compared to in a situation in which the elements are not present in such hierarchies.

### RELATED APPLICATIONS

The present application is related to and claims priority from the co-pending India Patent Application entitled, “DETERMINING DATA ELEMENTS IN HETEROGENEOUS SCHEMA DEFINITIONS FOR POSSIBLE MAPPING”, Serial Number: 637/CHE/2006, Filed: Apr. 6, 2006, naming the same inventors as in the subject patent application.

### RELATED APPLICATIONS

The present application is related to the co-pending U.S. application Ser. No. 11/164,362, Filed: Nov. 21, 2005, entitled, “Generating A Synonym Dictionary Representing A Mapping Of Elements In Different Data Models”, which is incorporated by reference in its entirety into the present application.

### BACKGROUND OF THE INVENTION

1. Field of the Invention

The present invention relates generally to computer implemented applications, and more specifically to a method and apparatus for determining data elements in heterogeneous schema definitions for possible mapping.

2. Related Art

A schema definition generally defines a structure using which data of interest can be stored or represented. Typically, the structure contains a set of elements (“data elements”) of corresponding types, and potentially the order and inter-relationship between the data elements. For example, a schema may represent the columns of a table in a relational database, and more complex hierarchical structures in extended markup language (XML), object oriented programming, etc.

Different schemas are often used by different (heterogenous) applications, possibly representing some overlapping information (with corresponding overlap of data elements). For example, a payroll application may contain the employee names and identifiers, in addition to salary, amounts paid, dates, etc, using a corresponding schema (“payroll schema”). Similarly, a human resources (HR) application may also contain the employee names and identifiers, in addition to join date, title, qualifications, etc., using another schema (“HR schema”).

There is a recognised need to map data elements of different schemas. For example, there are several situations in which complex applications are developed independently (possibly without coordination) potentially on different software platforms (e.g., Enterprise Resource Planning (ERP), Customer Relationship Management (CRM)), and efforts are made much later to inter-operate (or integrate) the two applications.

At least to correlate the data of the applications, there is a need to map the data elements across heterogenous schemas. The resulting mapping generally indicates which data element contained in a schema corresponds to (or is the same as) which data element(s) of other schemas. The resulting mapped data may be viewed as containing synonym pairs.

One prior approach to obtain such synonym pairs is to first have a digital processing system suggest possible mapping of elements of one schema definition to elements of another schema definition, and then have the user confirm or remove the indicated possible mappings, or add new pairs (one from each schema) to generate the synonym pairs.

In one prior embodiment, data elements for possible mapping are identified based on attributes such as the type of data contained in the data elements, name of the data elements and hierarchy of the data structure in which data elements are present etc. For example, two data elements contained in different data structures, which have a common name (and are located in the same hierarchy), may be identified as a data element pair for possible mapping.

However, there is a general need to enhance the accuracy of suggesting possible mapping of elements since that would correspondingly increase the mapping efficiency. What is therefore needed is an improved method and apparatus for determining data elements in heterogeneous schema definitions for possible mapping.

### BRIEF DESCRIPTION OF THE DRAWINGS

The present invention will be described with reference to the accompanying drawings briefly described below.

FIG. 1 (FIG.) 1 is a block diagram of an example environment in which various aspects of the present invention can be implemented.

FIG. 2 is a block diagram illustrating an example embodiment in which various aspects of the present invention are operative when software instructions are executed.

FIG. 3 is a flowchart illustrating the manner in which data element pairs for possible mapping can be determined according to several aspects of the present invention.

FIG. 4 contains a display of the definition of two schemas used to illustrate the operation of an embodiment of the present invention.

FIG. 5A contains a graphical user interface using which a user may specify preferences for mapping of data elements in the schema in an embodiment of the present invention.

FIG. 5B contains a graphical interface which displays element pairs from the schemas which have been identified for mapping and the corresponding probability of mapping without operation of some features of the present invention.

FIG. 6A contains a graphical interface using which a user can specify that a non-leaf node of a first schema is similar (“structural similarity”) to a non-leaf node of a second schema.

FIG. 6B depicts a text file representing a structural dictionary containing the structural similarities specified by the user in an example scenario.

FIG. 7A contains a graphical user interface using which a user may specify preferences and structural dictionary used in determining data elements for possible mapping.

FIG. 7B contains a user interface illustrating the enhanced probabilities of mappings due to the use of the specified structural similarities.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

Overview

According to an aspect of the present invention, a user can specify non-leaf elements of two schemas as being structurally similar and a software application computes match indicators with a greater probability of possible mapping between leaf nodes (below the respective non-leaf nodes of the schemas) using the specified structural similarities. Such greater values increase the efficiency of generating synonym dictionary since the user can quickly select the suggested pairs having greater probability.

Several aspects of the invention are described below with reference to examples for illustration. It should be understood that numerous specific details, relationships, and methods are set forth to provide a full understanding of the invention. One skilled in the relevant art, however, will readily recognize that the features of the invention can be practiced without one or more of the specific details, or with other methods, etc. In other instances, well known structures or operations are not shown in detail to avoid obscuring the features of the invention.

### 2. EXAMPLE ENVIRONMENT

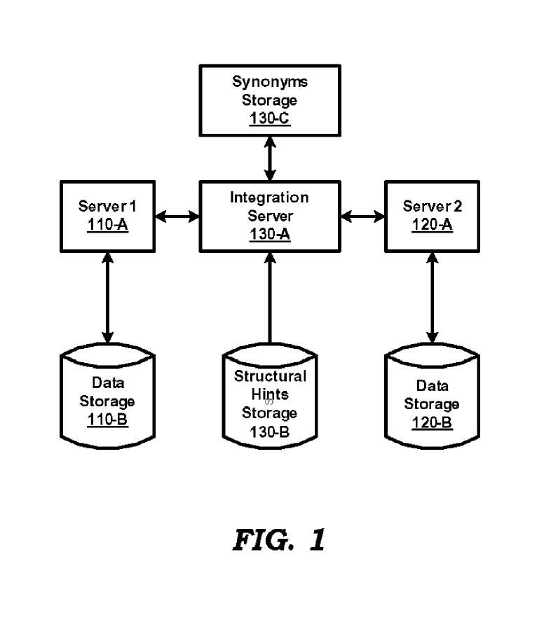

FIG. 1 is a block diagram of an example environment in which various aspects of the present invention are implemented. The environment is shown containing servers 110A and 120A, data storages 110B and 120B, structural hints storage 130B, integration server 130A and synonyms storage 130C. Only representative components (in number and kind) are shown for illustration. Each block of FIG. 1 is described below in further detail.

Server 110A executes a user application (e.g., using software platforms such as CRM applications, ERP Applications) while accessing the corresponding information stored in data storage 110B. Similarly, server 120A executes another user application while accessing the corresponding information stored in data storage 120B. It is assumed that data elements accessed by applications executing on server 110A may be represented in a corresponding schema definition and those accessed by applications executing on server 120A may be represented in another corresponding schema definition.

Data storage 110B and data storage 120B store corresponding information according to respective schema definitions required by corresponding applications on servers 110A and 120A respectively. Each schema definition contains data structures and corresponding data elements as noted above in the background section.

Synonyms storage 130C contains information regarding data elements which have been determined to be synonym pairs. In an embodiment, data elements contained in different schema definitions are indicated as synonym pairs by user actions and the synonym pairs are stored in a text file in synonyms storage 130C.

Integration Server 130A facilitates either inter_operation of the applications executing on servers 110A and 120A, or alternatively provides new features by using the information in both data storages 110B and 120B and synonyms storage 130C. At least to facilitate the operation of integration server 130A, it may be desirable to determine the synonym pairs.

Structural hints storage 130B contains information (“structural hints”) indicating the non-leaf nodes of different schemas which have been determined to be structurally similar (for example, as specified by a user), and can be used to enhance the efficiency of generating the synonym pairs (in synonym storage 130C) as described below in further detail.

3. Digital Processing System

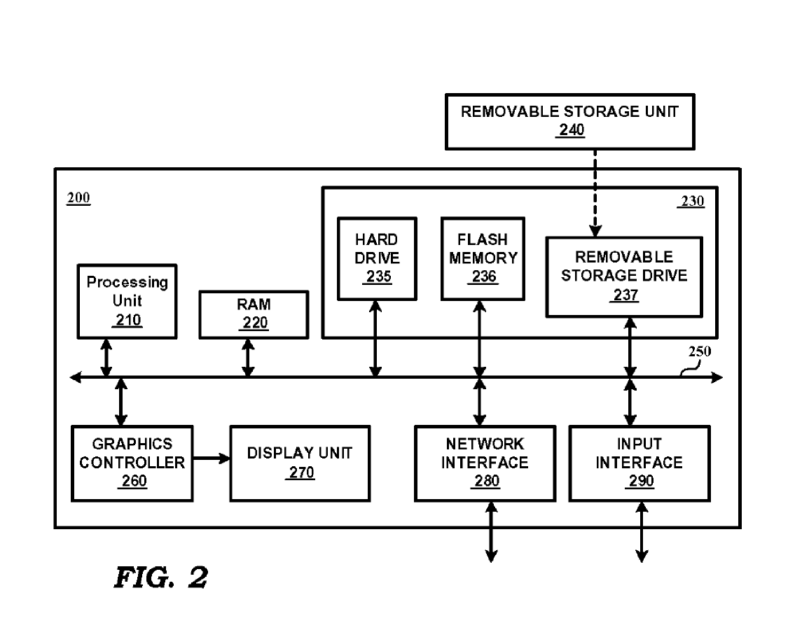

FIG. 2 is a block diagram illustrating the details of a digital processing system 200 using which data elements in heterogeneous schema definitions for possible mapping can be determined according to various aspects of the present invention. As will be described below in further detail, determination of such element pairs may improve the efficiency of mapping of data elements.

Digital processing system 200 may contain one or more processors such as central processing unit (CPU) 210, random access memory (RAM) 220, secondary memory 230, graphics controller 260, display unit 270, network interface 280, and input interface 290. All the components except display unit 270 may communicate with each other over communication path 250, which may contain several buses as is well known in the relevant arts. The components of FIG. 2 are described below in further detail.

CPU 210 may execute instructions stored in RAM 220 to provide several features of the present invention. CPU 210 may contain multiple processing units, with each processing unit potentially being designed for a specific task. Alternatively, CPU 210 may contain only a single general purpose processing unit. RAM 220 may receive instructions from secondary memory 230 using communication path 250.

Graphics controller 260 generates display signals (e.g., in RGB format) to display unit 270 based on data/instructions received from CPU 210. Display unit 270 contains a display screen to display the images defined by the display signals. Input interface 290 may correspond to a key-board and/or mouse. Network interface 280 provides connectivity to a network (e.g., using Internet Protocol), and may be used to communicate with the other systems of FIG. 1.

Secondary memory 230 may contain hard drive 235, flash memory 236 and removable storage drive 237. Secondary memory 230 may store the data (e.g., the schemas sought to be mapped, structural hints as well as synonym dictionary generated according to various aspects of the present invention) and software instructions, which enable digital processing system 200 to provide several features in accordance with the present invention.

Some or all of the data and instructions may be provided on removable storage unit 240, and the data and instructions may be read and provided by removable storage drive 237 to CPU 210. Floppy drive, magnetic tape drive, CDROM drive, DVD Drive, Flash memory, removable memory chip (PCMCIA Card, EPROM) are examples of such removable storage drive 237.

Removable storage unit 240 may be implemented using medium and storage format compatible with removable storage drive 237 such that removable storage drive 237 can read the data and instructions. Thus, removable storage unit 240 includes a computer readable storage medium having stored therein computer software and/or data.

In this document, the term “computer program product” is used to generally refer to removable storage unit 240 or hard disk installed in hard drive 235. These computer program products are means for providing software to digital processing system 200. CPU 210 may retrieve the software instructions, and execute the instructions to provide various features of the present invention, as described below.

4. Method

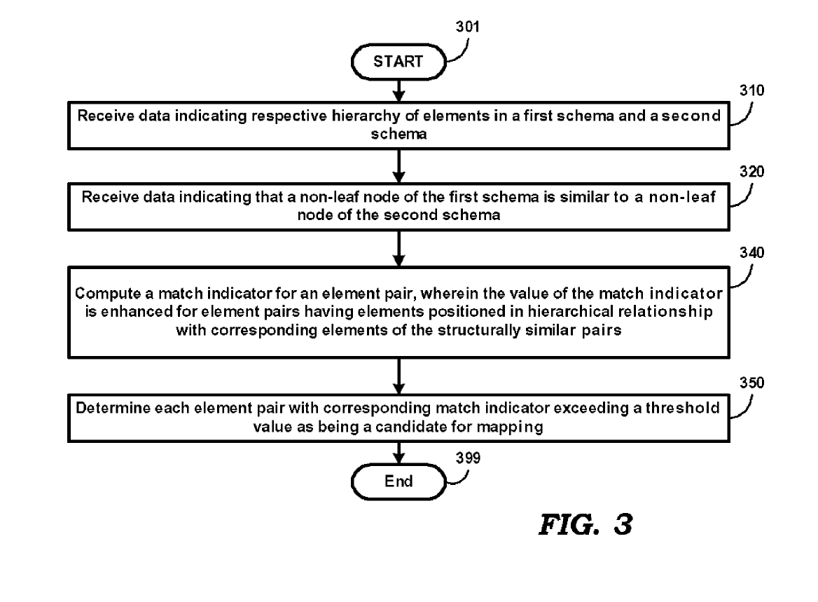

FIG. 3 is a flowchart illustrating the manner in which digital processing system 200 may determine data element pairs for possible mapping according to various aspects of the present invention. The flowchart is described with respect to FIGS. 1 and 2 merely for illustration. However, the approach(es) can be implemented in other systems/environments as well. The flowchart begins in step 301, in which control passes to step 310.

In step 310, digital processing system 200 receives data indicating respective hierarchy of elements in a first schema and a second schema. With reference to the environment of FIG. 1, the data may indicate the schema definitions representing the data stored in data storage 110B and 120B respectively. In such a scenario, a user may provide identifiers of the respective files storing the first schema and the second schema, and digital processing system 200 may retrieve the data contained in the two files.

In step 320, digital processing system 200 receives data indicating that a non_leaf node of the first schema is similar to a non_leaf node of the second schema. The two non-leaf nodes are said to be structurally similar. It is assumed that the non-leaf nodes correspond to parent data elements (“ancestors”) which are indicated in a higher position in a hierarchy representing the schema. With reference to FIGS. 1 and 2, digital processing system 200 receives data indicating non-leaf nodes in schema definition contained in data storage 110-B which are similar to corresponding non-leaf node in the schema definition contained in data storage 120B. In an embodiment, digital process system 200 receives such data in a text file [i.e. xsl or xquery] and the user may specify the file identifier by appropriate user interface.

In step 340, digital processing system 200 computes a match indicator for an element pair, wherein the value of the match indicator is enhanced for element pairs having elements positioned in hierarchical relationship with corresponding elements of the structurally similar pairs. In an embodiment, a match indicator is computed based on several other similarity conditions, in addition to the structural similarity information. The match indicator may be computed as a weighted average of the similarity conditions as described with examples in sections below.

In step 350, digital processing system 200 determines each element pair with corresponding match indicator exceeding a threshold value as being a candidate for possible mapping. The user may conveniently be provided the option of confirming the element pairs as being synonym pairs, and the corresponding pairs may be stored in synonym storage 130C. Control passes to step 399, where the flowchart ends.

The approach described above can be implemented to generate synonym dictionaries based on various schemas, with corresponding formats. The schemas being mapped can potentially have different formats. The description is continued with example schemas files from which synonym dictionary is generated according to various aspects of the present invention.

### 5. EXAMPLE SCHEMAS

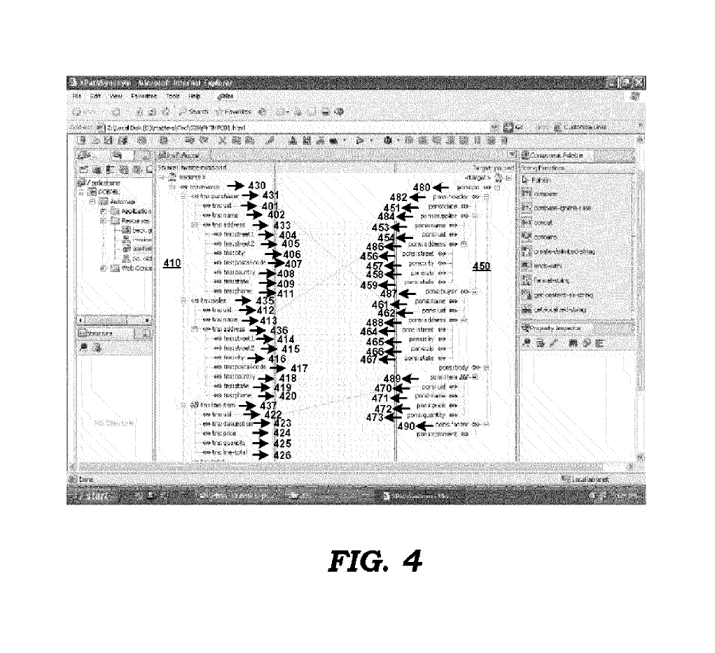

FIG. 4 contains a display of two schema definitions represented using Extended Markup Language (XML) Schema definition (XSD). Only the portions of the schemas as relevant to an understanding of the features of the present invention are included/described for conciseness. Portion 410 is shown representing the hierarchy of data elements in a schema “invoice” and portion 420 is shown representing another hierarchy of data elements in another schema “po” (purchase order) data. The schemas of FIG. 4 are described briefly below.

As may be appreciated, the schema structure illustrates the organization of data elements in a hierarchy with some data elements appearing below other data elements. The data elements, which appear at the lowest level of hierarchy are termed as “leaf nodes”, while the other data elements appearing at higher levels are referred to as “non-leaf nodes”.

With reference to the schemas of FIG. 4, in portion 410, data elements indicated by 430, 431, 433, 435, 436 and 437 are non_leaf nodes with the corresponding labels as “invoice”, “purchaser”, “address”, “seller”, “address”, “line_item” of the “invoice” schema.

Similarly, in portion 420, data elements indicated by numbers 480, 482, 484, 486, 487, 488, 489 and 490 indicate non_leaf nodes with the corresponding names as “po”, “header”, “supplier”, “address”, “buyer”, “address”, “item” and “footer” for the “po” schema. As may be appreciated, the two data elements with the name “address” (486 and 488) appear under corresponding non_leaf nodes “header” (482) and “buyer” (487). Some of the non_leaf nodes indicated above have leaf elements as described below.

Continuing with the description of the invoice schema, the non_leaf node “purchaser” (431) has two leaf elements as “uid” (401) and “name” (402) which appearing below the non_leaf node in the corresponding hierarchy. Similarly, non_leaf node “address” (433) has leaf elements as “street1” (404), “street2” (405), “city” (406), postal code (407), “country” (408), “state” (409) and “phone” (411). Other non_leaf nodes “seller” (435), “address” (436) and “line_item” (437) have corresponding leaf elements as indicated by the lines {412, 413}, {414_420} and {422_426}.

As may be appreciated, in the “po” schema, non_leaf nodes “header” (482), “supplier” (484), “address” (486), “buyer” (487), “address” (488) and “item” (489) have the corresponding leaf elements as {451}, {453, 454}, {456_459}, {461, 462}, {464_467}, {470_473}.

The description is continued with an illustration of a graphical user interface using which a user may specify preferences to use while identifying data elements for possible mapping in an embodiment of the present invention.

6. Specifying Preferences for Mapping

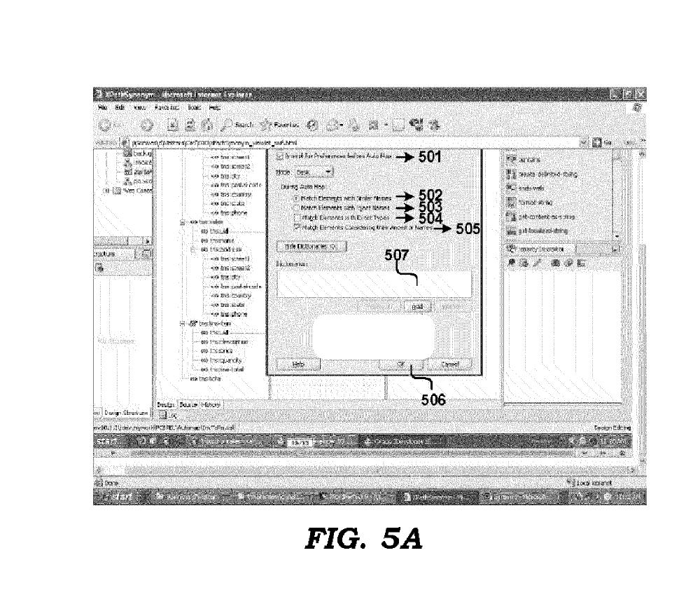

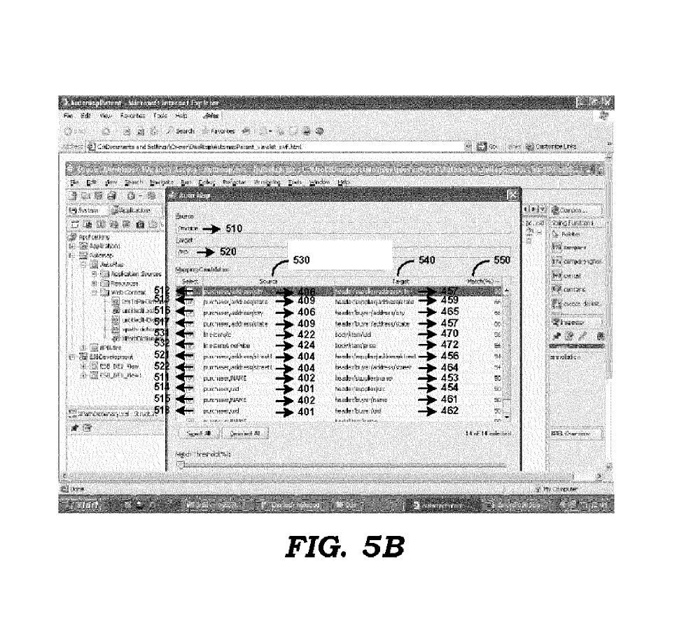

FIG. 5A contains a graphical user interface using which users may specify any additional match conditions to consider while identifying data elements for possible mapping. Various controls of FIG. 5 are described briefly below.

Selecting control 501 enables users to indicate the specific ones of similarity conditions 502, 503, 504 and 505, which would need to be used in determining the match indicators. Selecting radio button control 502 indicates that only data elements with similar names are to be considered for determination of element pairs for possible match. Similarly, selecting radio button control 503 indicates that only data elements with exactly the same names are to be considered for determination of element pairs for possible match.

Selecting control 504 indicates that the data elements should be of same type for them to be considered as element pairs for possible match. For example, with reference to FIG. 4, the data element in portion 410 and the corresponding data element in portion 420 should be one of data type supported (e.g., numeric, long etc.).

Similarly, selecting control 505 enables the name of the ancestors of corresponding data elements to be considered while determining the element pairs. Selection of “OK” control (506) enables computation of a match indicator based on the selected additional match conditions.

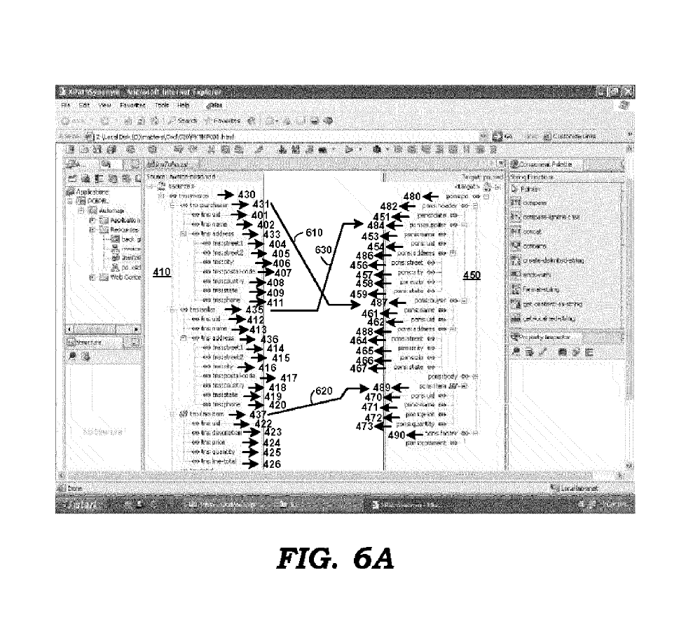

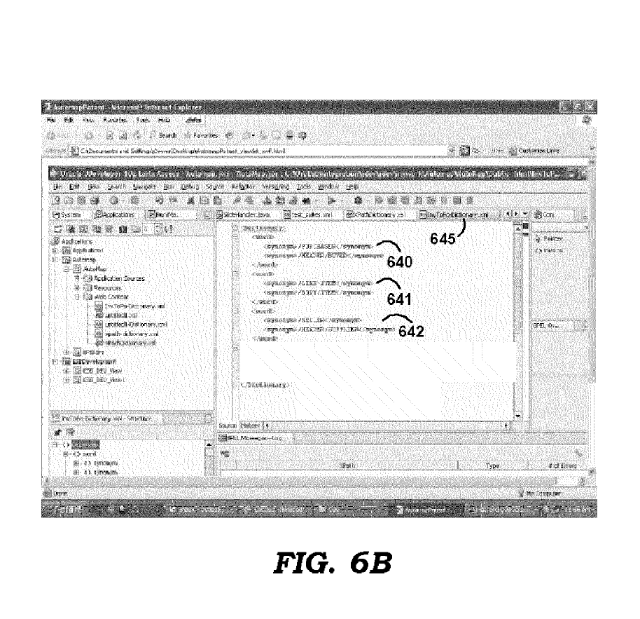

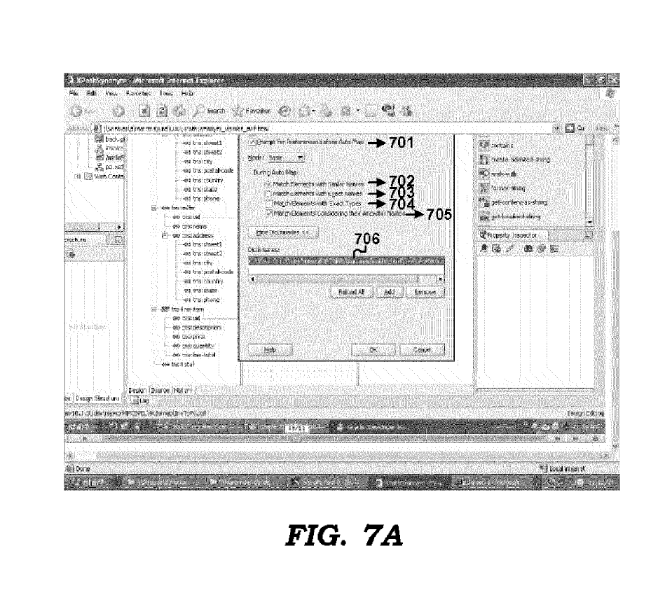

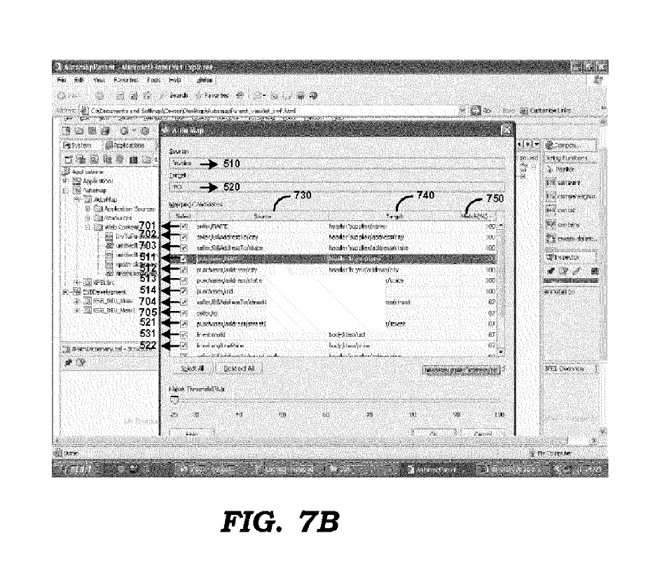

As noted above, the probability of possible match is enhanced when the user indicates structural similarities (by indicating the corresponding structural similarities dictionary in area 507). Due to the absence of the dictionary (which provides structural hints) in area 507, the probability values are lower (compared to when a dictionary with structural similarities is specified), as described below with respect to FIGS. 5B-7B. In particular, FIG. 5B displays the match indicators corresponding to the selection of FIG. 5A (i.e., no structural similarities specified), FIGS. 6A-7B illustrate the manner in which match indicators are enhanced due to the use of structural similarity information.

7. Without Using Structural Hints

FIG. 5B contains a graphical display screen containing some of the element pairs with the corresponding probability of mapping, when structural hints are not used. The contents of FIG. 5B are described briefly below.

Display portions 510 and 520 indicate that the data elements contained in the schemas of “invoice” (410) (as source schema) and “po” (420) (as target schema, to which mapped) are considered for determination of the element pairs for possible match. Element pairs and the corresponding match indicator values appear under columns source (530), target (540) and match (550) respectively.

As may be appreciated, line 512 contains the source (leaf) data element (under column 530) as “purchaser/address/city”, which corresponds to the leaf element “city” (406) under the non_leaf node “address” (433) which in turn is under another non_leaf node “purchaser” (431). Line 512 contains target data element (under column 540) as “header/supplier/address/city”, which corresponds to the leaf element “city” (457) under non_leaf element “address” (486) which in turn appear under the non_leaf element “supplier” (484). Further, non_leaf element “supplier” (484) appears under another non_leaf element “header” (482). The match indicator contains a value as 66% under column match % (550).

Similarly, line 513 contains source data element as “purchaser/address/state” which corresponds to “state” (409) and target data element as “header/supplier/address/state” which corresponds to the data element “state” (459) with the value of match indicator as 66%.

In a similar representation, lines 516,517, 531,532, 521,522, 511, 514, 515 and 518 contain source data elements as “purchase/address/city” (406), “purchaser/address/state” (409), “line_item/id” (422), “line_item/lineprice” (424), “purchaser/address/street1” (404), “purchaser/address/street1” (404), “purchaser/NAME” (402), “purchaser/uid” (401), “purchaser/NAME” (402), “purchaser/uid” (401). The corresponding target data elements are respectively, “header/buyer/address/city” (465), “header/buyer/address/state” (,467), “body/item/uid” (470), “body/item/price” (472), “header/supplier/address/street” (456), “header/buyer/address/street” (464), “header/supplier/name” (453), “header/supplier/uid” (454), “header/buyer/name” (461) and “header/buyer/uid” (462).

Column 550 represents the match indicator for each row. In one embodiment, a value for each indicated similarity condition is determined based on computation of a weighted average using the equation:

Match Indicator=(A[structural probability factor]+B[linguistic similarity factor]+C[type probability factor]+)/(A+B+C) wherein A, B, and C represent the respective weights to be assigned to corresponding similarity condition (component in the right hand side of the Equation) contributing to the final value of match indicator. The remaining terms of the equation are described briefly below. In case, a similarity condition is not considered, the corresponding weight is treated as 0. Similarly, more factors can be considered by extending the formula above.

Linguistic similarity factor represents (numerically) the extent to which the spellings of the two elements are identical/similar. If the names of the two elements are identical, highest value may be assigned. In case they are not identical, the elements may be broken into sub-strings (recursively) and the sub-strings can be compared to arrive at an intermediate value between 0 and the highest value for this factor/component/similarity condition.

Type probability factor represents the likelihood that the data type of the two data elements is the same. In case of simple types such as number, varchar, text, etc., the likelihood can be determined easily. However, for complex data structures, additional examination (of the two data types)/computations would be needed to determine the type probability factor. Again, depending on the extent of match, a value between maximum permissible value and minimum value may be chosen.

Structural probability factor represents the enhanced probability that can be inferred if the ancestors (or even descendents) of the two data elements are known to be similar (or already mapped by other techniques). The closer the level of the ancestors, higher the probability. Various aspects of the present invention enable the contribution of this similarity condition to the match indicator to be enhanced, as described below in further detail.

As may be observed in FIG. 5A, due to selection of controls 502 and 505, similarity in names of the source data element and the target data element, and similarity of the names of the corresponding ancestor data elements are the similarity conditions considered while determining element pairs of lines 512-518 for possible match. The corresponding values of match indicators for some example pairs are described below in further detail, assuming weights of 5, 5, and 0 for A, B and C respectively in the above equation. Using the match conditions for data elements contained in line 512, it may be appreciated that the source data element and the target data element have identical names (city) and hence the value of linguistic similarity factor is determined to be equal to a value of 100. The hierarchy of non_leaf nodes for the source data element (“/purchaser/address”) and the target data element (“/header/supplier/address”) are different and hence the value of structural probability factor is determined to be equal to a value of 33. Accordingly, the value of match indicator can be computed as

(5*33)+(5*100)+0/(5+5+0) which equals to 66 as indicated in column 550.

Similarly, considering the data elements contained in line 531, it may be appreciated that the source data element (“id) and the target data element (“uid”) have values of linguistic similarity factor determined to be of value 75 due to sub-string match between source and target data elements and the value of structural probability factor for the data elements is determined to be 35 due to the difference in corresponding levels (line-item vs body/item) indicating the hierarchy. The corresponding value of match indicator can be computed to be 56 as indicated under column 550 for line 531.

According to an aspect of the present invention, the probability of matching of data elements can be enhanced, if users could indicate non-leaf nodes in the structure which represent a similarity of structure. Accordingly, the description is continued with an illustration of how users could indicate structural similarity of non-leaf nodes using a graphical user interface in an embodiment illustrated below.

8. Specifying Non-Leaf Nodes with Structural Similarity

FIG. 6A contains a graphical user interface using which a user can specify that a non-leaf node of a first schema is similar (“structural similarity”) to a non-leaf node of a second schema and FIG. 6B depicts a text file representing a structural dictionary containing the structural similarities specified by the user.

As may be appreciated, lines 610, 620 and 630 indicate the non-leaf nodes of “invoice” schema which are structurally similar to non-leaf nodes of “po” schema. Line 610 indicates that the non-leaf node “purchaser” (431) of “invoice” schema and “buyer” (487) are structurally similar. Similarly, line 620 indicates that the non-leaf node “line-item” (437) of invoice schema and “item” (489) of “po” schema are structurally similar.

Line 630 indicates that the non-leaf node “seller” (435) of “invoice” schema and “supplier” (484) of “portable wireless device 130” schema are structurally similar. It should be appreciated that elements at different levels (e.g., 610 and 630) in the hierarchy can be indicated to be structurally similar. The software instructions may receive the corresponding information from the appropriate input/output devices, and store the information in a text file, as described below.

FIG. 6B contains a text file containing the structural similarities specified by the user in FIG. 6A. The text file is identified by the name “InvToPo-Dictionary.xml” (645). As may be appreciated, the pair of non-leaf nodes which are structurally similar are contained within the tags “word” and “/word” and each of the pair of non-leaf nodes is enclosed within the tags “SYNONYM”, “/SYNONYM”.

Accordingly, the pair of non-leaf nodes indicated by 640, 641 and 642 correspond to lines 610, 620 and 630 respectively. As indicated earlier in the document, structural hints storage 130B stores the structural hints which are indicated by users. Accordingly, the text file of FIG. 6B may be stored in structural hints storage 130B.

The description is continued with an illustration of how the possibility of mapping can be enhanced by the use of structural similarity of non-leaf nodes according to several aspects of the present invention.

9. Enhanced Possibility of Matching of Data Elements

FIG. 7A contains an graphical interface using which users could indicate identifier(s) of the text file containing non-leaf nodes which are identified as structurally similar, in addition to the similarity conditions of the data elements to consider while determining element pairs for possible match. Accordingly, the controls of FIG. 7A are similar to the controls of FIG. 5A.

Accordingly, controls 701, 702, 703, 704 and 705 correspond to corresponding controls 501, 502, 503, 504 and 505. Value in control 706 indicates the identifier of the text file containing non-leaf nodes which are structurally similar. As may be appreciated, the value in control 706 contains the identifier of the file as indicated in portion 645.

FIG. 7B contains a user interface illustrating the element pairs with enhanced values for probabilities of mappings due to the use of structural similarities on non-leaf nodes. Column entitled “Source” (730) corresponds to data elements from “invoice” schema. Column entitled “Target” (740) corresponds to data elements in “po” schema.

It may be appreciated that the value of probability of match for the element pairs contained in lines 511-514 and 521 under match % (750) indicate a higher value as compared to the corresponding value under the column match % (550), due to use of indication of the structural similarity between the non-leaf nodes “purchaser” in the “invoice” schema and “buyer” in the “po” schema (as in line 640). The corresponding enhanced values of match indicators for some example pairs are described below in further detail, assuming weights of 5, 5, and 0 for A, B and C respectively in the above equation.

Due to structural similarity as indicated in line 640, it may be appreciated that for the data elements contained in line 512, the value of structural probability factor is determined to a new value of 100 and hence the value of match indicator is re-computed as

(5*100)+(5*100)+0/(5+5+0) which equals to 100 (under column 750), thus indicating an enhanced probability of mapping.

Similarly, for the data elements contained in line 531, due to the structural similarity as provided in line 641, the value of structural probability factor is determined to be 100 and accordingly the value of probability factor can be computed as 87 (under column 750) there by enhancing the probability of mapping.

Similarly, the value of probability of match displayed under “match %” (750) for element pairs contained in lines 531 and 532 is higher as compared to corresponding values under match % (550) due to the use indication of the structural similarity between the non-leaf nodes “line-item” in the “invoice” schema and “item” in the “po” schema (as in line 641).

It may be appreciated that data elements of lines 701-705 indicate the additional element pairs for possible match which are determined based on indication of structural similarity between the non-leaf nodes “seller” in the “invoice” schema and “supplier” in the “po” schema (as in line 642).

The probabilities thus computed can be used to suggest possible matches and the user can confirm or reject the proposals. However, due to the higher values of match indicators computed due to the indication of structural similarities, the efficiency of synonym generation can be enhanced, as desired.

### 10. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents. Also, the various aspects, features, components and/or embodiments of the present invention described above may be embodied singly or in any combination in a data storage system such as a database system and a data warehouse system.

What is claimed is:

1. A method of generating a plurality of synonym pairs from a first schema and a second schema, said first schema including a first plurality of elements according to a first hierarchy and said second schema including a second plurality of elements according to a second hierarchy, wherein each synonym pair contains a leaf element from each of said first schema and said second schema and wherein the two leaf elements correspond to each other, said method comprising:
receiving a first data indicating that a pair of non-leaf elements are structurally similar, said pair of non-leaf elements containing a first non-leaf element and a second non-leaf element respectively contained in said first schema and said second schema; and
computing a probability of possible match between a first leaf element and a second leaf element respectively contained in said first schema and said second schema,
wherein said probability of possible match as a synonym pair is greater if said first leaf element is in a branch from said first non-leaf element in said first hierarchy and said second leaf element is in another branch from said second non-leaf element in said second hierarchy, than otherwise.

2. The method of claim 1, wherein said computing comprises:
receiving a second data indicating a plurality of similarity conditions of said first leaf element and said second leaf element to consider for performing said computing;
determining a corresponding one of a plurality of indicative values representing a level of match between said first leaf element and said second leaf element only based on respective one of said plurality of similarity conditions; and
calculating said probability of possible match using said plurality of indicative values.

3. The method of claim 2, wherein said probability of match is computed according to a weighted average of said plurality of indicative values.

4. The method of claim 3, wherein said plurality of similarity conditions comprise a structural similarity representing whether said leaf element is in said branch from a corresponding hierarchy and a linguistic similarity between said first leaf element and said second leaf element.

5. A computer readable medium carrying one or more sequences of instructions causing a system to generate a plurality of synonym pairs from a first schema and a second schema, said first schema including a first plurality of elements according to a first hierarchy and said second schema including a second plurality of elements according to a second hierarchy, wherein each synonym pair contains a leaf element from each of said first schema and said second schema and wherein the two leaf elements correspond to each other, and execution of said one or more sequences of instructions by one or more processors contained in said server causes said one or more processors to perform the actions of:
receiving a first data indicating that a pair of non-leaf elements are structurally similar, said pair of non-leaf elements containing a first non-leaf element and a second non-leaf element respectively contained in said first schema and said second schema; and
computing a probability of possible match between a first leaf element and a second leaf element respectively contained in said first schema and said second schema,
wherein said probability of possible match as a synonym pair is greater if said first leaf element is in a branch from said first non-leaf element in said first hierarchy and said second leaf element is in another branch from said second non-leaf element in said second hierarchy, than otherwise.

6. The computer readable medium of claim 5, wherein said computing comprises:
receiving a second data indicating a plurality of similarity conditions of said first leaf element and said second leaf element to consider for performing said computing;
determining a corresponding one of a plurality of indicative values representing a level of match between said first leaf element and said second leaf element only based on respective one of said plurality of similarity conditions; and
calculating said probability of possible match using said plurality of indicative values.

7. The computer readable medium of claim 6, wherein said probability of match is computed according to a weighted average of said plurality of indicative values.

8. The computer readable medium of claim 7, wherein said plurality of similarity conditions comprise a structural similarity representing whether said leaf element is in said branch from a corresponding hierarchy and a linguistic similarity between said first leaf element and said second leaf element.
